(19) United States
(12) Patent Application Publication
(10) Pub. No.: US 2020/0079162 A1
(43) Pub. Date: Mar. 12, 2020

(54) Replacement Valve Stem Assembly

(71) Applicant: Mark W. Wyne, Wildwood, MO (US)

(72) Inventor: Mark W. Wyne, Wildwood, MO (US)

(21) Appl. No.: 16/602,307

(22) Filed: Sep. 9, 2019

Related U.S. Application Data
(60) Provisional application No. 62/765,759, filed on Sep. 12, 2018.

(51) Int. Cl. B60C 29/02

(52) U.S. Cl. CPC B60C 29/02

(57) ABSTRACT

A valve stem assembly, incorporating an expansion part, having a tapered inner portion that can be forcefully applied into the rim aperture of a tire, and having an outer portion that and into which an insert is applied, and into which insert a valve stem threadedly engages, when assembling the valve stem assembly of this invention.

### CROSS REFERENCE TO RELATED APPLICATION

This is a nonprovisional patent application that claims priority to the provisional patent application having Ser. No. 62/765,759, filed on Sep. 12, 2018.

### FIELD OF THE INVENTION

This invention relates to a valve stem assembly, a valve stem that can be removed, when it becomes defective and no longer functions, and can be replaced by a valve stem that pressure fits within the rim of the tire, without necessitating the removal of its tire from the rim, or the wheel from the vehicle, during repair and replacement.

### BACKGROUND OF THE INVENTION

As noted, this invention relates to a replacement valve stem assembly. One that can be replaced without necessitating the removal of the tire, or its rim, from the vehicle, during performance of a repair function.

There have been many patents relating to valve stems, tire valves, tire valves that are used upon and applied to the rim of vehicle, as will be noted. Usually, when a valve stem goes bad, the entire rim and tire must be removed from the vehicle, the tire from its rim, and then the defective valve stem can be removed from the rim and replaced. It is a time consuming project. The current invention alleviates that.

Various patents have been obtained upon valves, for use upon a vehicle tire, and one can be noted in the U.S. Pat. No. 8,661,886, upon a Valve Stem Grommet Structure. But, in this particular instance, the entire assembly obviously must be removed, since the valve has a pressure sensor applied internally, for determining the tire air pressure, and usually such can be transmitted to the dashboard and panel of the vehicle, to provide an indication and reading of the amount of air in that particular tire.

U.S. Pat. No. 8,631,695, is upon an Extended Valve Stem Cap, which incorporates an attachment to the end, apparently internally, that can be applied to a pressure sensor, also, for determining tire air pressure, and providing a read out of the same.

There are a variety of other patents that are also available, and relevant to the subject matter relating to tire valves and valve stems, and such can be seen in U.S. Pat. No. 5,016,668, that shows a connection for extensions of inflating valves for motor vehicle tires. The particular valve assembly described in this patent is quite different from the current invention.

A valve extension shown in U.S. Pat. No. 4,445,527, shows another more complex type of extension device, that can be applied to an existing tire valve stem.

U.S. Pat. No. 4,481,970, shows another tire valve. This particular patent shows a valve which has its own peculiar shape, as can be noted.

U.S. Pat. No. 7,379,800, upon a tire pressure monitoring using hall effect sensors, shows a tire pressure monitoring system that uses a complex series of magnets and circuitry for monitoring the tire pressure.

U.S. Pat. No. 7,441,452, is upon a TPMS sensor assembly and method therefore, which is also used in conjunction with a vehicle rim.

U.S. Pat. No. 7,578,052, shows a valve stem installation system and method of installing a valve stem. This apparently is an automated system for applying valve stems into a rim, as at the plant.

U.S. Pat. No. 7,647,693, shows a valve stem installation system and method of installing the valve stem. This shows a related valve stem installation system as noted in the prior patent.

U.S. Pat. No. 7,647,693, shows a valve stem assembly for tire pressure detecting systems. This is a totally different structure from the usage and application of the invention described herein.

U.S. Pat. No. 8,146,413, shows a two-part tire valve stem, having a different form of what appears to be a dual type of valve.

U.S. Pat. No. 8,650,945, shows a retention member on a valve stem sealing grommet. It appears, from reviewing this device, that it is used in conjunction with a tire sensing means, and that it must be installed from inside of the rim, meaning the tire must be removed, to attain its installation.

U.S. Pat. No. 8,955,535, shows a valve stem repair kit and method. This device shows another valve stem kit, as shown in the companion U.S. Pat. No. 9,162,327, as can be seen, and these two devices counterbore a tapered bore in which a supplemental valve stem may be threaded therein, or countersunk therein, in order to repair a failed valve.

U.S. Pat. No. 9,248,706, upon an apparatus for coupling a TPMS wheel unit and a valve stem into an assembly, the assembly and installation thereof, shows an entirely different structure for a valve and its stem, and for use for different purposes. U.S.

U.S. Pat. No. 9,499,016, shows a related valve stem as the previous patent, primarily for use for coupling a TPMS wheel unit together.

These are examples of what prior art are available relating to valve stem technology, and their application and usage to a rimmed tire.

### SUMMARY OF THE INVENTION

The concept of the current invention, essentially, is when a valve stem wears out, you simply want to cut off the existing failed valve, probably push the bottom half interiorly of the tire and rim, and then from the outside, pressure fit a new valve into position, all without having to remove the rim from the vehicle, or to remove the tire from its rim, since the entire valve structure can be replaced exteriorly of the tire and its rim.

The structure of the current invention is to provide simply a three part valve stem assembly, that includes an expansion part, sometimes called an expansion port, having a particular contoured shape so as to provide for its pressure insertion into the rim aperture exteriorly where such a valve locates, and then having an insert that threadedly or otherwise engages into the expansion part, followed by the application of a valve stem, or core, within the insert, to complete the assembled product. Then, because of the contour of the expansion part, and which may be made of a silicone rubber, polymer, or other elastic material, can be pressure fitted into seating within the rim aperture, where the valve normally locates, all from exteriorly of the tire, and without necessitating the removal of the rim, or its tire, to attain such application and eventual usage.

The expansion part includes the resiliently formed part, that has a truncated shape at its bottom half, that half that normally locates within the rim, so as to facilitate the insertion, and pressure fitting by way of sliding compressive action into the rim aperture, until the rim locates within an annular groove, that locks the expansion part into position upon the rim, for immediate usage. Then, an insert may threadedly engage within that part, and a valve, such as a Schrader valve, comprising a valve stem, or core, can be threadedly engaged within the insert, to complete the assembly of the unit, ready for refilling of the tire with pressurized air, and its immediate application and usage.

There is a channel that extends centrally, and longitudinally, entirely through the valve stem assembly, as can be understood, so that air may be injected under pressure through the valve stem, through the cylindrical opening through the insert, and the lower part of the expansion part, for injection, under pressure, into the tire to attain its inflation. Obviously, the valve stem, because of its unique design, prevents the escape of any pressurized air through the valve, once it is injected into the tire under pressure.

It is, therefore, the principal object of this invention to provide a valve stem assembly, comprising components only made up of an expansion part, an insert, and a valve stem, all of which may be easily installed from exteriorly of the rim, when replacement is required.

Another object of this invention is to provide a valve stem assembly that can replace a defective valve, without necessitating the removal of the tire or rim from the vehicle, or the tire from its rim, during installation and usage of the assembly of this invention.

Still another object of this invention is to provide an expansion part, for a valve stem assembly, that has unique contours, that facilitates its pressure insertion into the valve rim aperture during its installation and assembly.

Still another object of this invention is to provide an expansion part, for a valve stem assembly, and into which a valve insert may be threadedly or otherwise engaged, and ready for reception of a valve stem, during assembly and installation.

These and other objects may become more apparent to those skilled in the art upon review of the subject matter of this invention, and upon undertaking a study of the description of its preferred embodiment, in view of the drawings.

### BRIEF DESCRIPTION OF THE DRAWINGS

In referring to the drawings:

FIG. 1 provides an exploded view of the valve stem assembly of this invention, showing its expansion part, the insert, and the stem valve or core;

FIG. 2 is a side view of the expansion part of this invention, showing its insert applied therein;

FIG. 3 is a sectional view through just the expansion part of this invention;

FIG. 4 is a left end view of the expansion part of FIG. 3; and

FIG. 5 is a longitudinal sectional view through the entire assembly, showing the expansion part, its insert threadedly engaged therein, and the valve stem threadedly engaged within the insert.

### DESCRIPTION OF THE PREFERRED EMBODIMENT

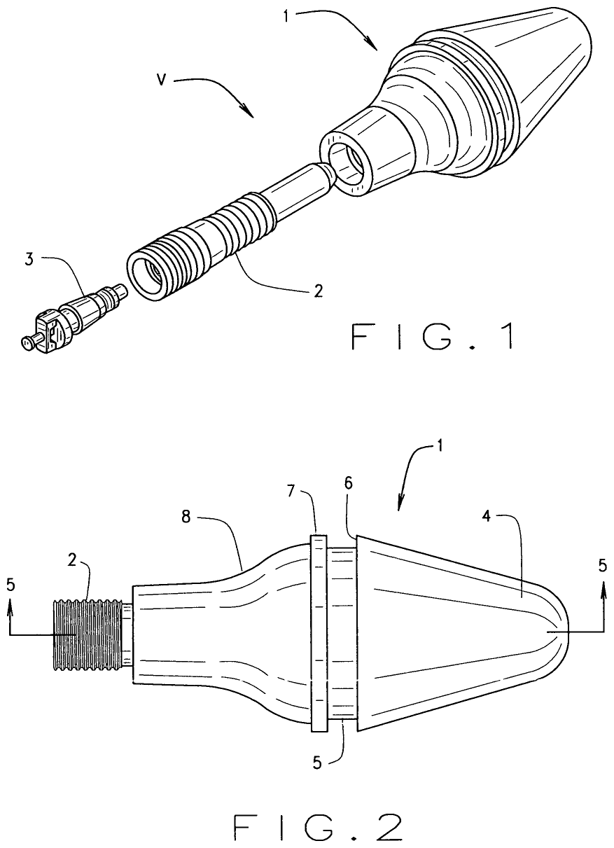

In referring to the drawings, and in particular FIG. 1, therein can be seen the valve stem assembly V of this invention. It includes it expansion part 1, as noted, and into which at its outer end, an insert 2 threadedly engages therein. Then, the valve stem or core 3, itself, threadedly engages within the insert, so as to complete the entire assembly. The entire assembly is made up of just these three parts.

As can be seen in FIG. 2, which is a side view showing the assembly completed, the expansion part 1 is made up, integrally, of three parts, an inner part 4, which when the assembly is installed, locates within the rim. Then, at its midpoint, it has a formed groove 5, and this groove is designed, and has dimensions, that allows for its snug application within the rim aperture, that tightly biases against the inner surface of the formed groove 5, as it is installed. Then, the contoured portion 4 has an outwardly extension, as at 6, and that biases against the interior of the rim, around the periphery of its aperture, and said part also includes a cylindrical flange, as at 7, integrally formed, and that biases against the exterior of the rim aperture, when the assembly is installed. Then, exteriorly of the expansion part is the integrally shaped and formed outer portion 8 of the assembly, and its expansion part, and that remains exteriorly of the rim, when the assembly is installed onto a tire. Then, as noted, an insert 2 threadedly engages within the outer portion 8 of the expansion part, during its assembly.

As can be seen in FIG. 3. The expansion part 1, in the cross sectional view provided herein, has a central channel 9 that extends longitudinally entirely through the full length of the part, as can be noted. The channel widens at the vicinity of its midpoint, as at 10, and then it is threadedly formed, as at 11, and the tire part accommodates the threaded engagement of the insert 2, within the same, during assembly.

The various contours for the expansion part, can be seen in FIG. 4.

There is also a widen opening, as at 12, outside of the integral threads 11, in order to allow for the insert 2 to be conveniently located therein, during its insertion and threaded application within the assembly.

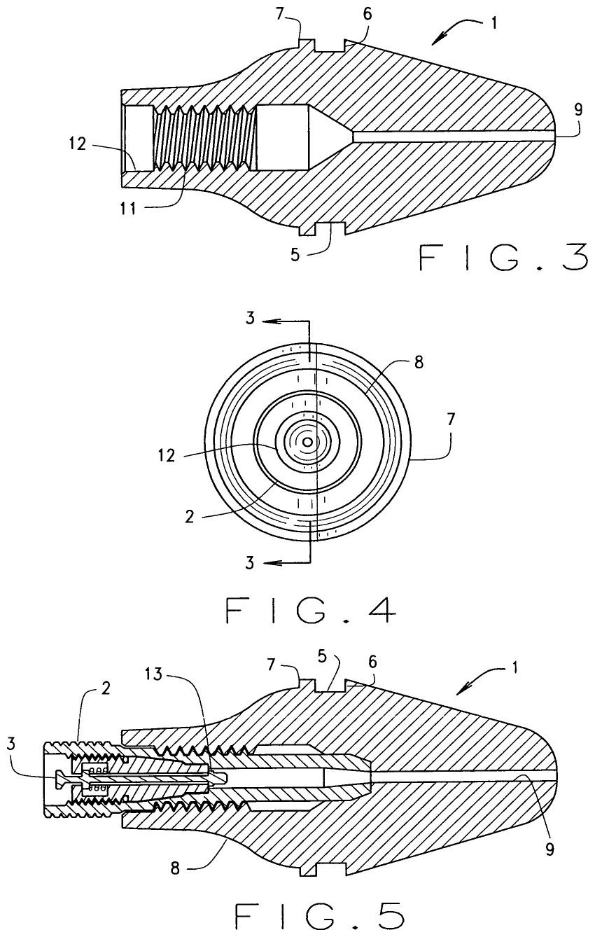

FIG. 5, in longitudinal cross section, shows the entire valve stem assembly with all of its three components assembled together. The expansion part 1 has its insert 2 threadedly engaged therein, and the valve stem or core 3 threadedly engages within the insert as can be noted.

The expansion part 1, as previously explained, has resiliency, and may be made of rubber, a resilient polyurethane, or other polymer, and has a useful durometer hardness, so that when it is pressure fitted within the aperture of the rim, it can be compressed, until such time as the entire interior portion 4 of the part locates within the rim, so that the rim can be forced over the integral lip 6, and seat within the circular groove 5, when ready for further assembly and usage. The insert 2 may be formed of polymer, or metal, and preferably brass. The valve core 3 is the standard type of valve stem, and has been readily known and used in the art. An adhesive may also be applied into the groove 5 to further adhere and further seal the valve to the rim.

The expansion part 1 does have its insert to threadedly engaged therein, as can be seen in FIG. 5 and then the standard type valve stem 3 threadedly engages within the insert 2, and provides a valved mechanism, as at 13 which, when the valve stem 3 is forced inwardly, allows for the valve to open, and to allow for the admission of pressurized air through the central channel 9 into the tire, to provide for its inflation. Or, when it is desired to release pressurized air from within the associated tire, the valve stem 3 can still be pushed inwardly, to open its valve 13, and allow for air to escape from the tire, as is known in the art.

The most effective usage of the current invention is attained by utilizing a rubber or flexible polymer in the formation of the expansion part of the valve assembly. Usually, the expansion part will have sufficient resiliency so as to allow it to be forcefully applied into the rim of the vehicle, through its rim aperture, until the tire rim locates within the formed groove 5 of the assembly. It has been found that utilizing an expansion part, that has, for example, a durometer hardness made of rubber, between about 60 to 80 has been satisfactory during usage when applying the valve stem assembly into the rim of a vehicle. The preferable durometer hardness of the expansion part is believed to be around 70.

Variations or modifications to the subject matter of this invention may occur to those skilled in the art upon review of the invention as described herein. Such variations, if within the spirit of this invention, for providing a valve stem assembly that can be conveniently applied to the rim of a tire, without the removal from the vehicle, it is believed to be an advancement in this art, and any variations or modifications within the spirit of this invention are intended to be encompassed within the scope of the claims to patent protecting issuing herein. The description of the preferred embodiment herein and its depiction in the drawings, are set forth for illustrative purposes only.

I claim:

1. A replacement valve stem assembly, including for use for installation through an air valve aperture in a wheel rim with the valve extending out of its rim and tire when applied to a vehicle, the valve stem assembly comprising an expansion part, said expansion part having an inner portion that is tapered to facilitate its pressure fitting within the rim aperture of a vehicle wheel, an outer portion integrally formed with the inner portion of the assembly and provided for remaining exteriorly of the vehicle rim when installed, said inner portion having an outward extension that biases against the interior of the rim when said assembly is forcefully installed through the rim, said outer portion of said assembly forming an integral cylindrical flange for biasing against the rim when installed, and said cylindrical flange and said outward extension of the inner portion forming a groove there between to seat the apertured tire rim within said groove when said replacement valve assembly is installed;
said valve stem assembly having a central channel extending through its longitudinal length to allow pressurized air to be injected into the tire or to be released from the inflated tire during operation; and
a valve insert threadedly engaged within said outer portion of said expansion part, and a valve stem fitted within said valve insert and together forming a valve to allow for the flow of pressurized air into the associated tire, to retain the pressurized air within the tire, or to release the air from the tire as required during servicing.

2. The replacement valve stem assembly of claim 1 wherein said expansion part is formed of one of rubber and polymer.

3. A replacement valve stem assembly of claim 2, wherein said expansion part is formed having resiliency, and the durometer hardness of the resilient expansion part is between about 60 to 80.

4. The replacement valve stem assembly of claim 3, wherein the durometer hardness of the expansion part is approximately 70.

5. The replacement valve stem assembly of claim 1, wherein the diameter of the cylindrical flange of the outer portion of the expansion part, and the outward extension of the inner portion of the expansion part each having a diameter greater than the diameter of the aperture of the wheel rim through which the valve stem assembly is forcefully applied and installed during usage.

6. The replacement valve stem assembly of claim 2, wherein said expansion part is formed of silicone rubber.

7. The replacement valve stem assembly of claim 5 and including an adhesive applied to the groove of the expansion part of said assembly to enhance the adherence and seal of said replacement valve stem assembly to the wheel rim.
